(19) United States
(12) Patent Application Publication
(10) Pub. No.: US 2017/0083954 A1
(43) Pub. Date: Mar. 23, 2017

(54) Obtaining Referral Using Customer Database

(71) Applicant: Reviews From Friends, Inc., Lewes, DE (US)

(72) Inventor: William B. Kurtz, Nashville, TN (US)

(21) Appl. No.: 15/370,228

(22) Filed: Dec. 6, 2016

Related U.S. Application Data
(63) Continuation-in-part of application No. 15/232,943, filed on Aug. 10, 2016.
(60) Provisional application No. 62/263,692, filed on Dec. 6, 2015.
(60) Provisional application No. 62/203,025, filed on Aug. 10, 2015.

(51) Int. Cl. G06Q 30/02; G06F 17/30; G06Q 50/00

(52) U.S. Cl. CPC G06Q 30/0282; G06Q 50/01; G06F 17/30867

(57) ABSTRACT

This invention relates to systems and methods for utilizing mobile computing systems to cross-reference one or more past customer databases of a business with the social network of a new customer in order to provide the new customer with a trusted referral from a known source about the company and/or product.

### CROSS-REFERENCE TO RELATED APPLICATIONS

This application claims the benefit of U.S. Provisional Patent Application Ser. No. 62/263,692 entitled “obtaining referral using customer database,” filed Dec. 6, 2015, the disclosure of which is incorporated by reference herein in its entirety.

This application is also a continuation-in-part of U.S. patent application Ser. No. 15/232,943 entitled “Provider Search Systems and Methods,” filed Aug. 10, 2016, which in turn claims the benefit of U.S. Provisional Patent Application Ser. No. 62/203,025 entitled “Provider Search and Ratings Application,” filed Aug. 10, 2015, the disclosures of which are incorporated by reference herein in their entireties.

### TECHNICAL FIELD

Aspects of the present disclosure relate to devices, systems, software and related business methods for sharing information among individuals, including software services and business model that share information among individuals in a social network where one of the individuals have already experienced the event, product and/or service that the other individual is interested in.

### BACKGROUND OF THE INVENTION

Customer reviews of businesses and products have expanded with the internet, but the increased importance and usage of these reviews have led to industries that manipulate these reviews to the benefit of the company or product. As a result, many of these anonymous reviews have become untrustworthy. This has impelled many future customers to return to asking their colleagues and friends for more personal referrals or reviews on products, services, and business.

Companies like Angie's list, Amazon, Healthgrades, Google and/or FourSquare obtain anonymous customer reviews from past customers, but many customer don't leave reviews because they do not feel “connected” to a person who might be later reading their reviews. A rather small portion of the population actively shares their activities, encounters, and purchases on social media websites like Facebook and Foursquare. These posts are shared with friends, family, as well as strangers. That level of openness may make some people reluctant to share all of their events, because they are not certain who will see them. A vast majority of people, however, feel awkward about sharing their purchases on these social media sites, but will often freely talk about their experiences and purchases in person with their friends and family. The lack of posting of events by a majority of the population means that a majority of encounters are not shared and commonly leads to selection bias of only reviews at the extremes—either really good or really bad.

### BRIEF SUMMARY OF THE INVENTION

The present invention includes the realization of the need for a filtered, blinded and/or anonymous matching system for individuals having experienced product or other goods and/or services from a third-party seller, such as an internet-based and/or brick and mortar (i.e., a physically accessible) goods or service provider, and other individuals who are planning on obtaining similar goods and/or services from the same or similar third party seller such as the service provider (for themselves or on behalf of someone else). In various embodiments, the disclosed system can include a preferred ratings agency model that anonymously (or using partially blinded and/or filtered contact methods) identifies linkages between past and prospective customers, and connects a prospective consumer with one of their friends or acquaintances that has already purchased the good or service or already seen that service provider, while still protecting the two peoples' identity to whatever degree each of the parties want their individual identities protected.

The following invention includes to use of business methods and/or software applications that create and/or utilize a past customer database for a particular business or businesses and allows a new customer to anonymously search this database for products that were purchased by individuals (i.e. trusted referrals) that also appear in the new customer's social networking apps. After the software determines a connection, the trusted referral remains anonymous and their identity protected unless they give permission to release their identity to the specific person or new customer. If permission is granted, then the trusted referral and new customer can communicate about the product or business. The past customer is given the opportunity to edit and share their information stored in the database. The number of connections between the new customer and past customers regarding a specific product or business may convey how popular of a certain product is with a customer's peer group and therefore how relevant the product is to the new customer. The number of connections for a product could be used to guide customers through searching and selecting the most appropriate products to purchase and to appropriately direct advertisements to customers.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings. The term smart phone desirably refers to any mobile electronic device, tablet, web-based program or computer of any type. The term app or application refers to a typical software program and could mean any computer code running on an electronic device or computer.

FIG. 1 depicts a flow diagram of one exemplary embodiment of a (FtF) software system where a new customer obtains a trusted referral from a friend through a shared database of multiple businesses and products;

FIG. 2 depicts a flow diagram of another exemplary embodiment of a (FtF) software system where a new customer obtains a trusted referral from a friend through a private database of a single business;

FIG. 3 depicts a flow diagram of another exemplary embodiment of a (FtF) software system where a new customer has created their FtF social network prior to their product search which allows enhanced search options;

FIG. 4 depicts a flow diagram of another exemplary embodiment of a (FtF) software system linking two past customers;

FIG. 5 depicts a flow diagram of another exemplary embodiment of a (FtF) software system asking a past customer to vouch for a new customer;

FIG. 6 depicts a flow diagram of another exemplary embodiment of a (FtF) software system allowing one individual or business to check the references of another individual through matching individuals in their social networks;

FIGS. 7a, 7b and 7c depicts one embodiment of a smart phone application with different searchable topics;

FIGS. 8a, 8b and 8c depict a one embodiment of a user searching through the FtF database for events that one of their anonymous friends has experienced;

FIGS. 9a, 9b and 9c depict one embodiment of a screen shot of a user viewing, editing, and/or sharing their own events;

FIGS. 10a, 10b, 10c and 10d depict one embodiment of a screen shot of an exemplary application where a user can share details about an event or experience with another individual through the application, text messaging, or email;

FIGS. 11a and 11b depicts one embodiment of a smart phone application where a user can build and/or edit their networks for different topics;

FIG. 12 depicts one embodiment of a screen shot of a user manually entering an event, activity, or purchase into a database;

FIG. 13 depicts one embodiment of a screen shot of an exemplary FtF software system including programming to make an educated “guess” about the user's activity and requesting that the user include that activity in their FtF database;

FIGS. 14a and 14b depicts one embodiment of a screen shot of a business or service provider asking their customer to include their experience in the FtF database;

FIGS. 15a, 15b and 15c depict one embodiment of a screen shot of the FtF software running inside a third party software;

FIGS. 16a and 16b depict one embodiment of a webpage running the FtF application where the user has already set up their FtF social network prior to product search;

FIGS. 17a, 17b, 17c, 17d and 17e depict one embodiment of a webpage running an FtF application where the user has not set up their FtF social network prior to product search; and

FIG. 18 depicts a one embodiment of a message being sent to a past customer from the FtF software asking for a referral on a product on behalf of their friend.

### DETAILED DESCRIPTION OF THE INVENTION

Generally, in terms of hardware architecture, various components of the system can include software programs resident upon computers and/or computing devices (including mobile computing devices) which include a processor, memory, and one or more input and/or output (I/O) devices (or peripherals) that are communicatively coupled via a local interface. The local interface may be, for example, but is not limited to, one or more buses or other wired or wireless connections, as is known in the art. A local interface may have additional elements, which are omitted for simplicity, such as controllers, buffers (caches), drivers, repeaters, and receivers, to enable communications. Further, the local interface may include address, control, and/or data connections to enable appropriate communications among the other computer components.

The processor can be a hardware device for executing software, particularly software stored in memory. Processor can be any custom made or commercially available processor, a central processing unit (CPU), an auxiliary processor among several processors associated with the computer, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. The processor may also represent a distributed processing architecture such as, but not limited to, SQL, Smalltalk, APL, KLisp, Snobol, Developer 200, MUMPS/Magic.

Memory can include any one or a combination of volatile memory elements (e.g., random access memory—RAM, such as DRAM, SRAM, SDRAM, etc.) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor.

The software in memory may include one or more separate programs. The separate programs can comprise ordered listings of executable instructions for implementing logical functions. In various embodiments, the software in memory can include a local interface on a smart phone or other mobile computing device in accordance with the present invention, including a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers, portable phones and smart phones, tablet computers and/or personal digital assistants (PDAs) (e.g., PalmOS available from Palm Computing, Inc., Android, iPhone OS or iOS, and Windows CE available from Microsoft Corporation). The operating system can essentially control the execution of other computer programs, such as the local interface on a mobile computing device and/or a server-based system for obtaining relationship link data, and can provide scheduling, input-output control, file and data management, memory management, and communication control and related services.

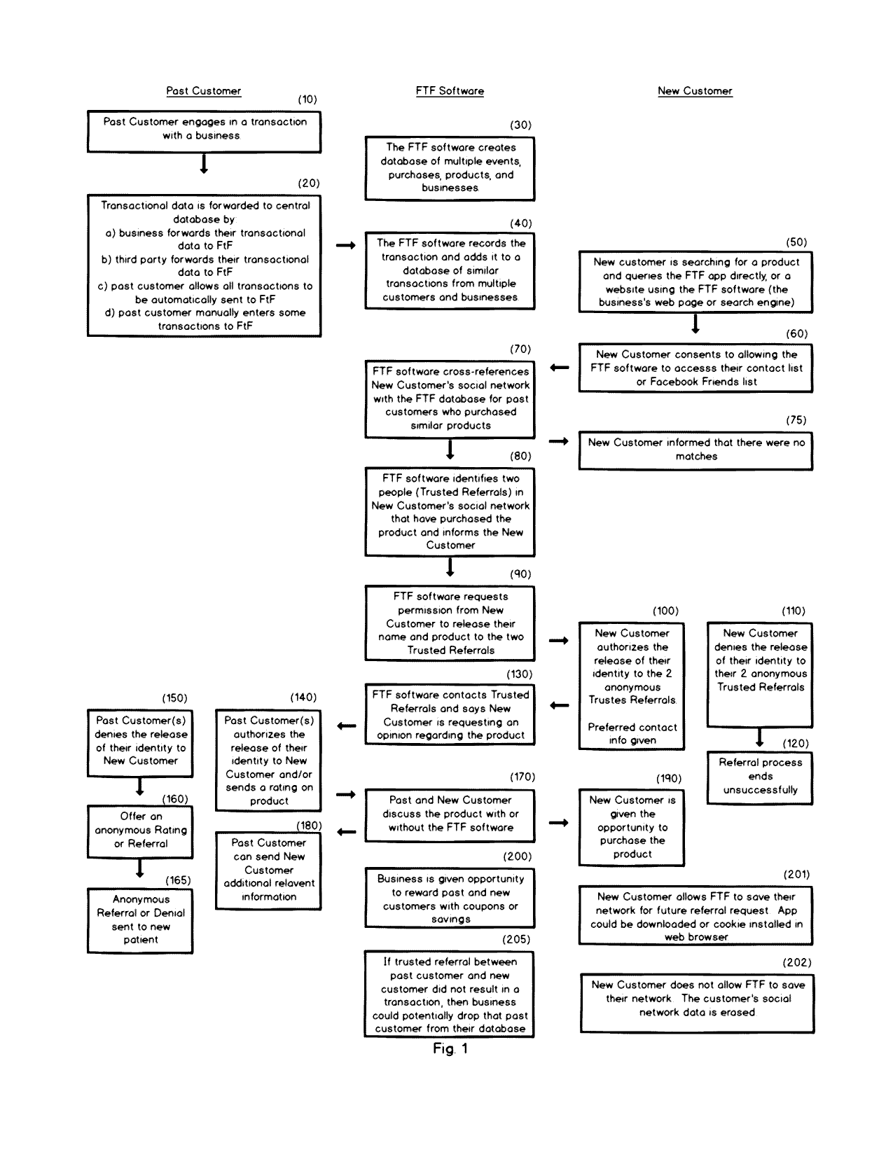

FIG. 1 depicts a flow diagram of one exemplary embodiment of a Friends-trust-Friends (FtF) software system and related business methods, where a new customer can obtain a “trusted referral” from a friend through a shared database of multiple businesses and products. In various embodiment, the FtF software can create a database of particular activities, events, or purchases by recording a customer's purchases or participation in events, or access such a database from other company records. The duty of recording these events could be the responsibility of the customer and/or the business and could be manual and/or automated. When a new customer is searching for the same event or product, the software could access a new customer's social network and cross-reference the shared database of past customers of the product with the new customer's social network. In FIG. 1, the transactional database is centralized and shared between multiple businesses so that a new customer can search multiple businesses and products at once.

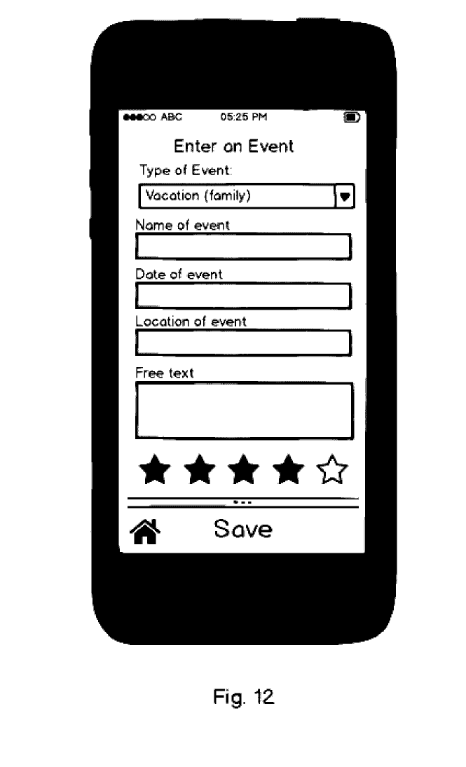

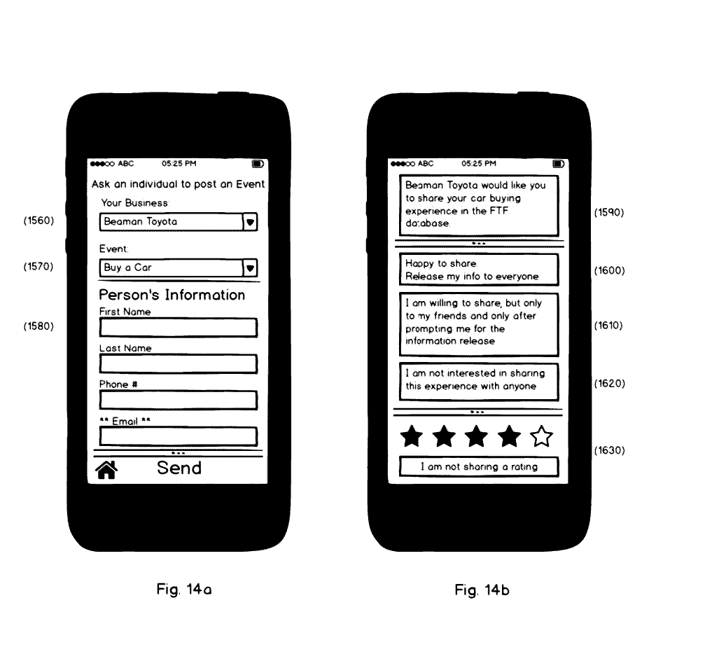

In the flow diagram in FIG. 1, the past customer engages in a transaction with a business. (10) The past customer's transactional data from their purchase can be entered into the database in multiple ways. (20) For instance, a past customer might purchase a car from a car dealer and that car dealer might manually or automatically forward the transactional data including customer name, customer's email, customer's phone number, type of car purchased, and/or rating of the customer's experience to the FtF database. If the past customer consented, then the past customer's social network could also be sent to the database to assist with cross-references at a later date. Alternatively, the past customer could enter the data manually. (FIG. 12) The business might also prompt the customer to enter their data into the FtF server. (FIG. 14) In addition, when a person initially signed on to the FtF app, the app might ask the customer to manually enter their car insurance carrier, their health insurance company, or the name of a general contractor they used to remodel their house. For transactions that generate electronic data like e-commerce purchases or credit card purchases, the past customer might give the FtF software permission to automatically record and enter the point of sale transactional data into the FtF database without the past customer having to manually enter the information or give consent each time. Lastly, the transactional information could be entered be a third party like Amazon. The past customer may use a site like Amazon to buy a book from a book dealer. Amazon could forward this transactional data on to the FtF database or keep the data in their own database. In various embodiment, this level of data collection may already occur in today's economy by multiple businesses. The collection or storage of this transactional data may require the past customer's consent, which could be obtained by the business (through their privacy policy or business agreement) or by the FtF software.

For the purpose of this flow diagram, the FtF software could create and maintain the transactional database. (30) In other forms, an individual business or a third party reseller (Amazon) could also create and maintain their own transactional database. If multiple databases existed, then they could function independently or collectively. If a business keep their own database, then they could edit their past customer list to serve their business interest. (205) The transactional data could be recorded and organized in the FtF database for later use. (40)

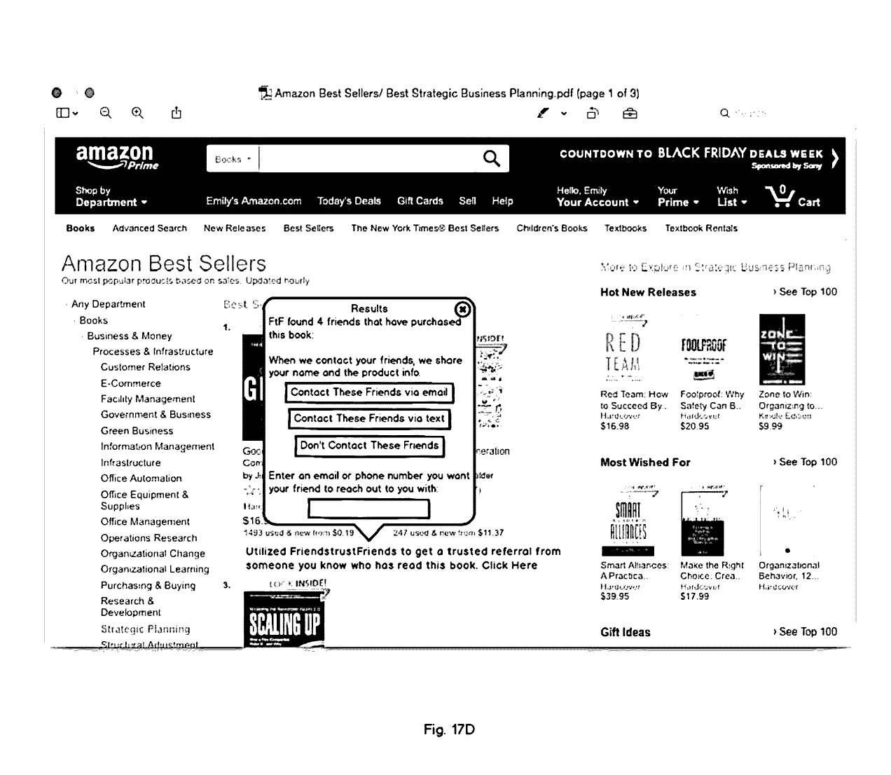

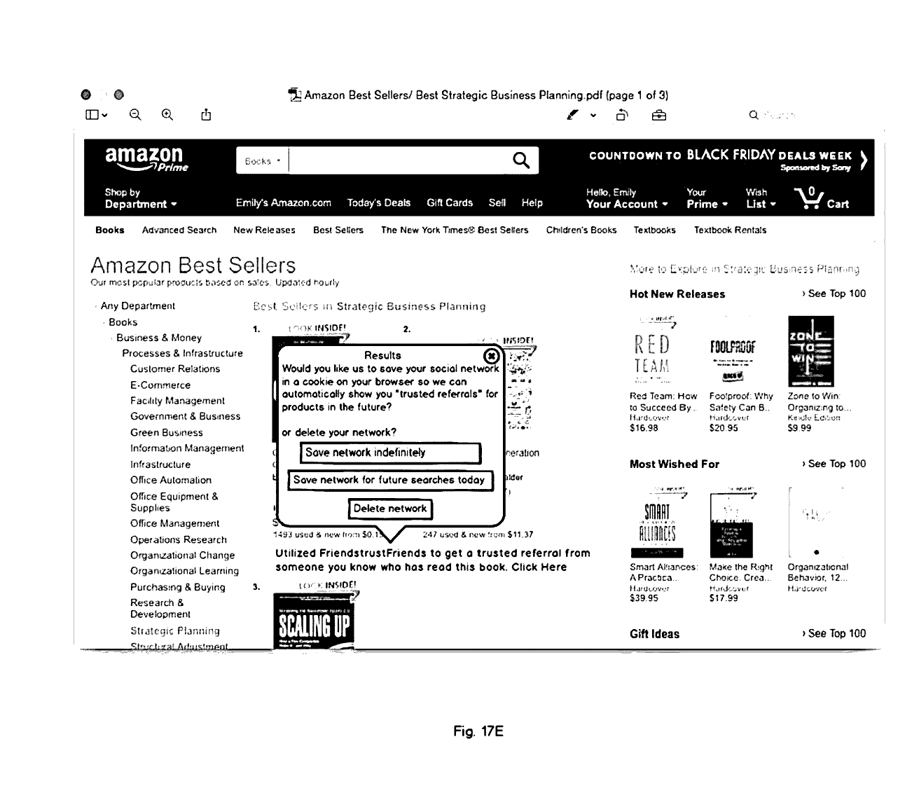

In the flow diagram of FIG. 1, a new customer is searching for a product as well as someone they know who has already purchased the product. (50) The new customer may be searching on a search engine website (Amazon, Google, etc.), the FtF search engine website, a business website (Car dealership's webpage), through an app of their mobile device or on a kiosk on the business's premises. (50) The new customer could have previously consented or consent at this time to have a social network created for their FtF search from their Facebook friend's list by logging in with their Facebook login name and password. (60 and FIGS. 17a,b,c) Other sources for creating a social network could be their recent email list, their contact list, Linked In contact list, Twitter list, Instagram list, etc. The FtF software could then look for matches (a.k.a. Trusted Referrals) between the new customer's social network and the past customer list for that searched product in the FtF database. (70) The past customer may become a “trusted referral” when the past customer who has purchased the product is matched up in a social network of a new customer that is searching for the same product. (80) Trusted referrals could be determined by matching names, email addresses, phone numbers, or other identifying data between the two lists. The FtF software might not find any trusted referrals and inform the new customer (75) or might find a few trusted referrals and inform the new consumer of the number of trusted referrals found. (80 and FIG. 17d) The trusted referrals could be listed for the product, the business, or both. The FtF software could then ask the new customer for permission to contact the trusted referrals and share the new customer's name and the product with the trusted referrals. (90) The new customer could either consent to the release of their name to the trusted referral thereby allowing the referral process to continue (100) or not consent to the release of their name and stop the referral process. (110) The FtF software could also ask the new customer for their preferred contact information for their friend to communicate with them or determine their contact information from the account they used to set up their social network (Facebook, etc.). (FIG. 17d) If the referral process continues, then FtF could contact the trusted referrals and ask them for their opinion on the product on behalf of the new customer and their permission to release their name to the new customer. (130)

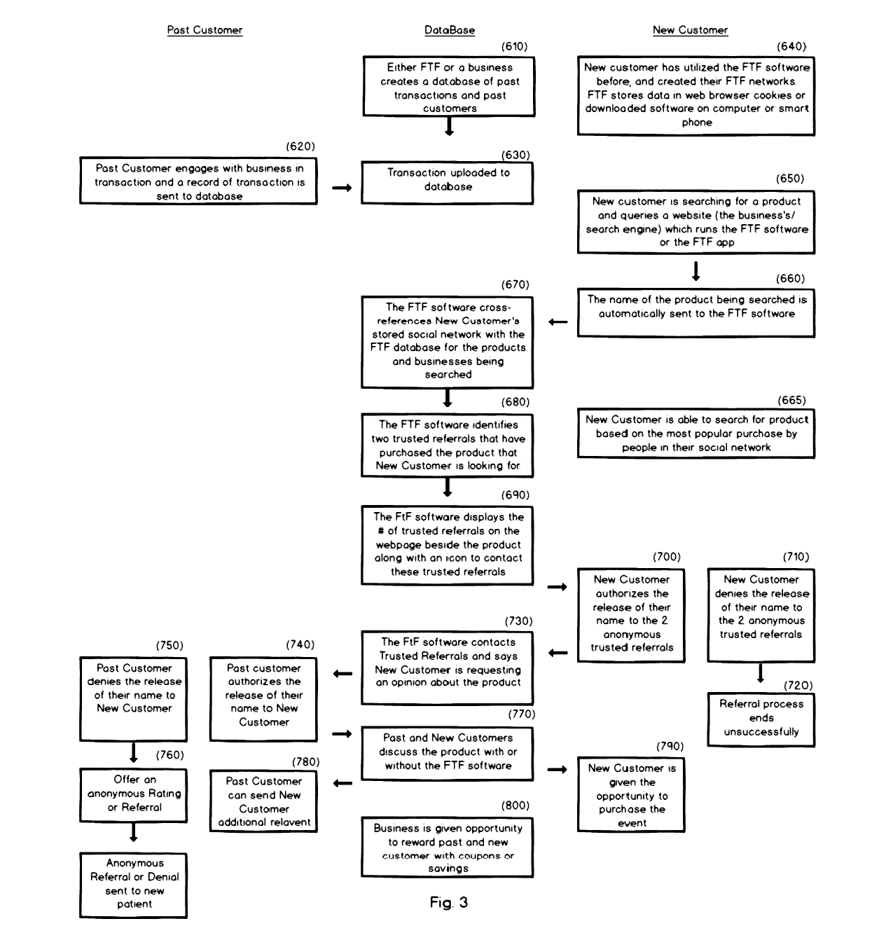

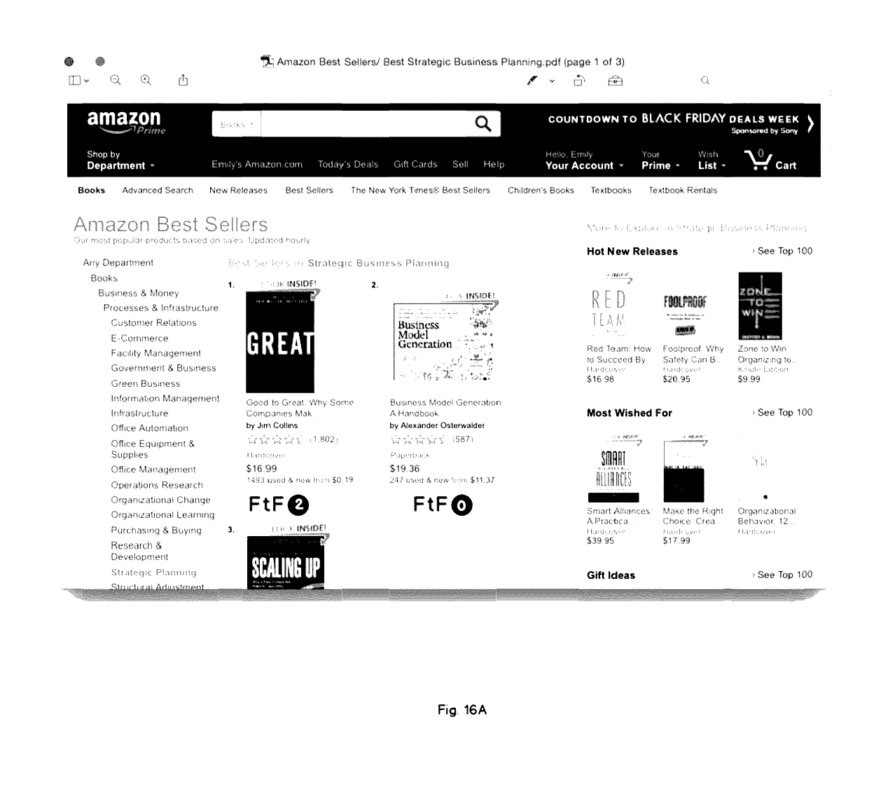

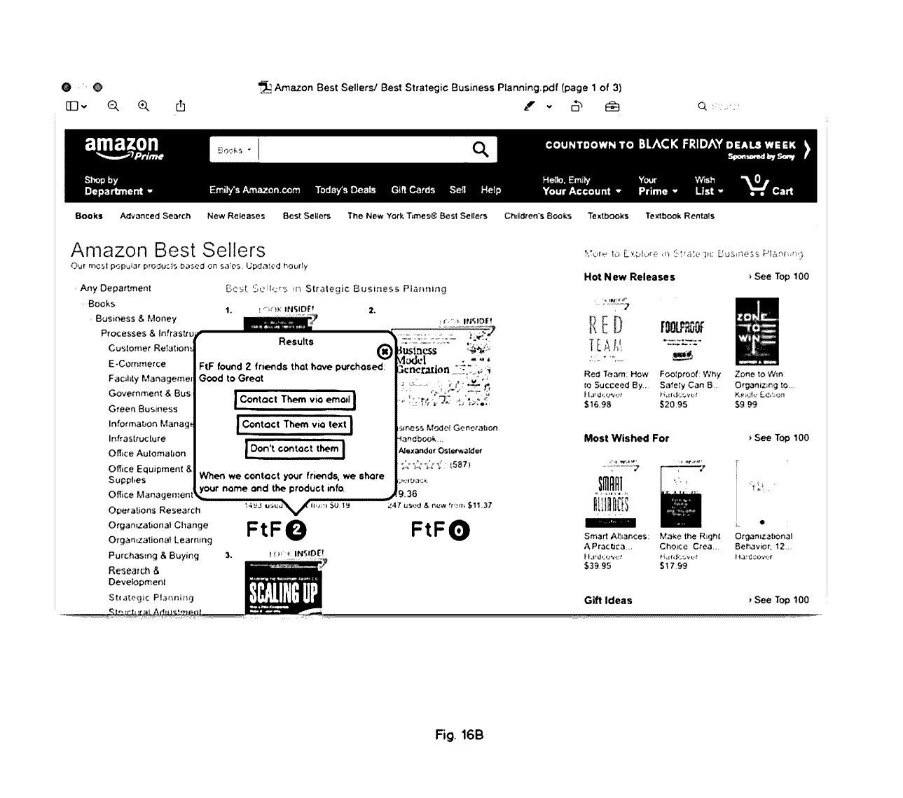

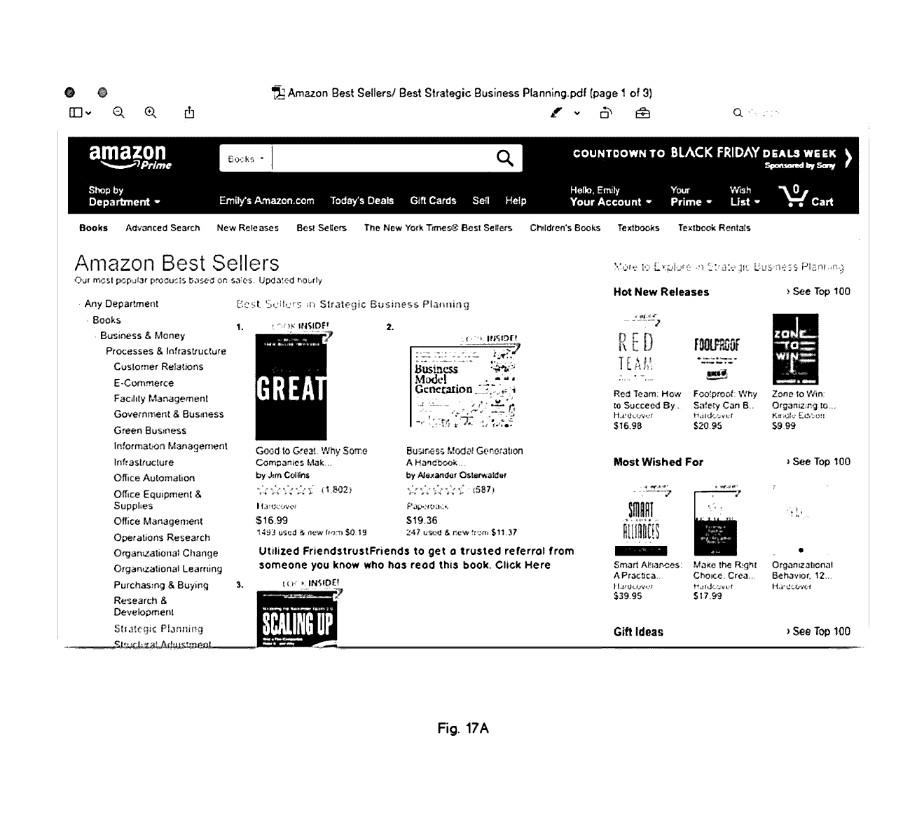

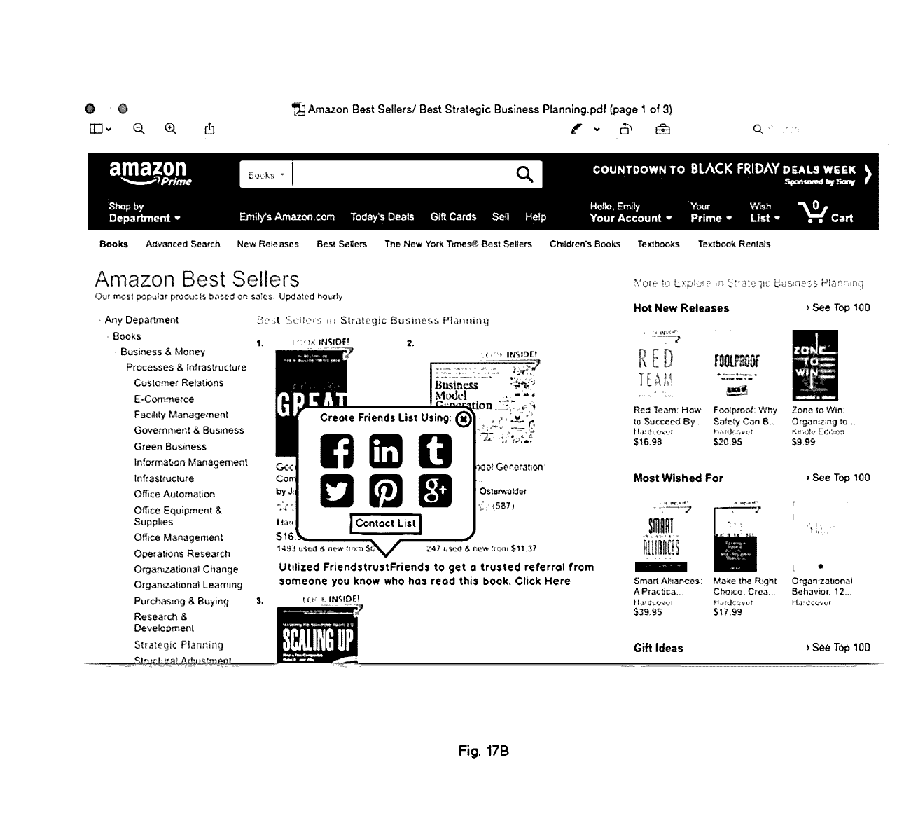

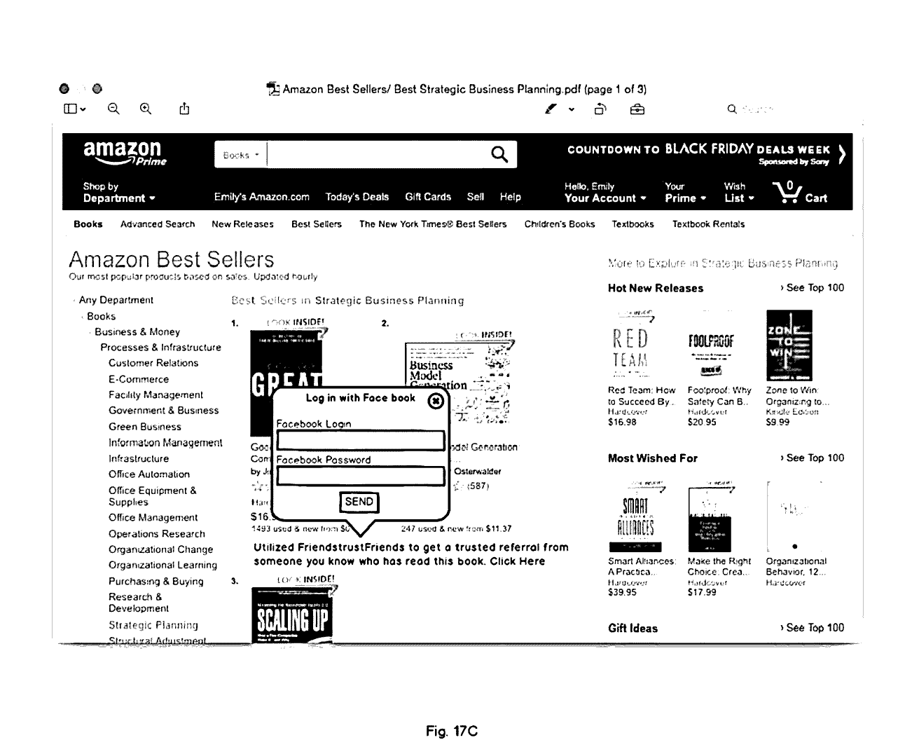

The past customer could view who was asking for their opinion or referral and which product they were asking about. (130) The past customer could still be anonymous to the new customer at this time, so the past customer could freely decide if they want to share their identity or opinion with the new customer. The past customer could decide to release their identity and/or their product rating to the new customer (140) or not. (150) If the past customer did not release their identity, (150) they could still opt to send an anonymous rating like 1 to 5 stars. (160) The anonymous rating and/or the past customer's refusal to release their name could be sent back to the new customer without the past customer's identity being disclosed. The FtF software could have sent a communication to other trusted referrals so there is still a chance that one of them might be willing to release their identity and/or rating to the new customer so the referral process could continue with them. If the past customer released their identity, they could also be asked to send a 1 to 5 star rating to the new customer. The past and new customers could then call, text or email each other to discuss the product further. (170) The FtF software could ask the past customer to fill out a questionnaire or ratings either at the time of purchase or when their friend contacted them through the FtF software. This questionnaire and other relevant information could be sent to the new customer after the past customer authorized the release of their ratings. (180) The past customer might also want to send the new customer other relevant information; for instance, if a new customer was searching for a beach house to rent in the Bahamas on a rental agency site like VRBO, then the past customer might send the address of the house they rented as well as the name of a great nearby restaurant that they ate at. The new customer could be given a chance to purchase the product right then through the app or webpage. (190) The business could reward the past and/or new customer with a coupon or reward for bringing in a new customer to the business. (200) The new customer could allow the FtF software to save their social network for future referral requests (FIG. 3, FIG. 16) in which case the new customer could download the app on their smart phone device or allow a file (i.e. browser cookie) to be inserted into the web browser on their computer. (201) The new customer might not allow the FtF software to save their social network and their social network would be erased. (202) The new customer's email might still be recorded for later contact.

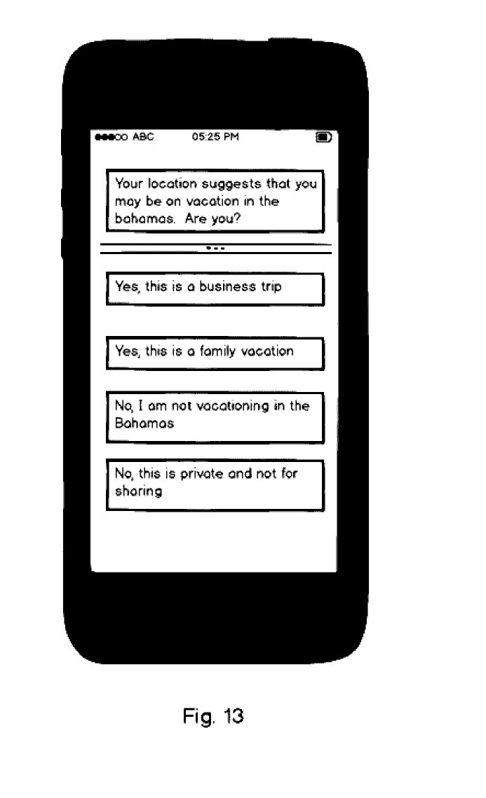

Areas of commerce that might perform well with customer-to-customer referrals through a centralized shared database could be service line business (plumbers, contractors, lawyers, insurance salesmen, physicians, etc.), expensive purchases like automobiles and electronics, and subjective experiences like travel, books, Broadway plays, etc. If a new customer searched for a topic, then the FtF software could follow up with the new customer at a later date to ask them to enter their data about whatever product they ultimately purchased (FIG. 13).

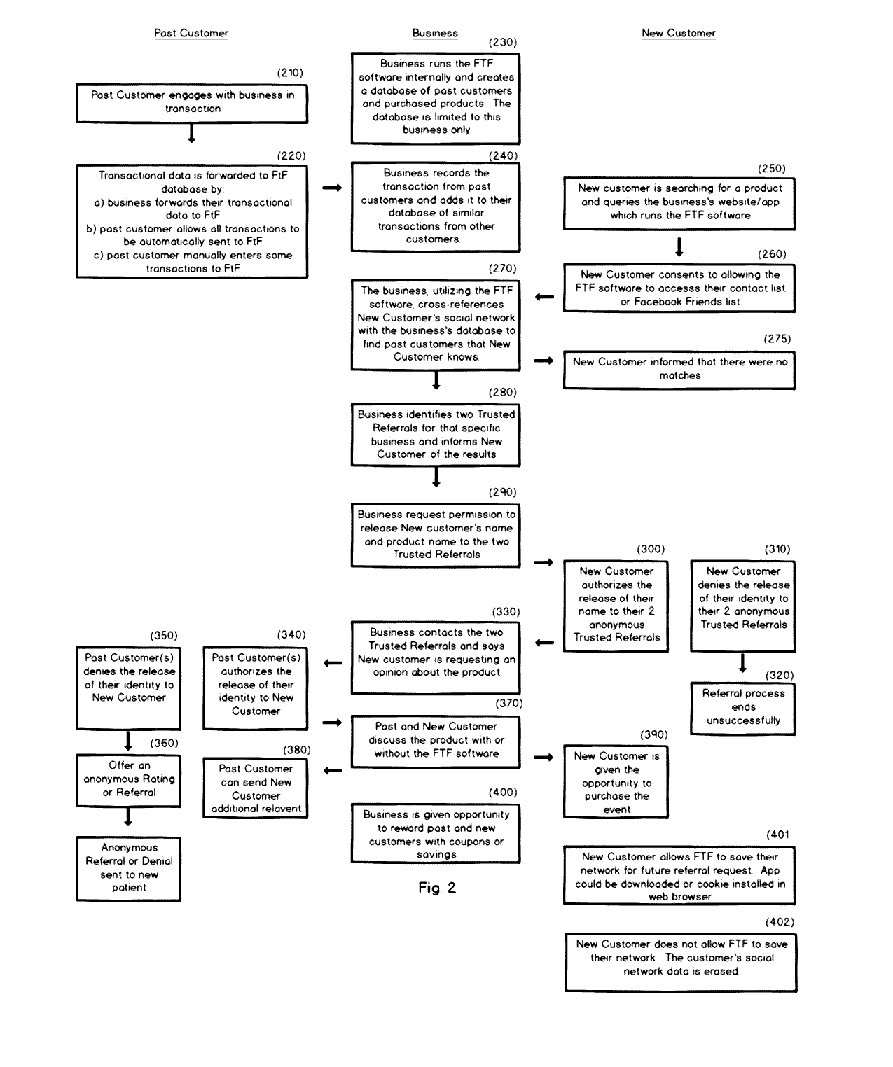

FIG. 2 depicts a flow diagram of another exemplary embodiment of a FtF software where a new customer obtains a trusted referral from a friend through a business's private database. One reason to allow a business to maintain their own database could be because the business has a vested interest in providing the new customer a trusted referral for their specific business or product and not a competing business or product. Therefore, a new customer that engages with a business (either through the business's webpage or physically walking into the business's location) could be shown trusted referrals from only that business. The flow diagram in FIG. 2 is otherwise very similar the system of FIG. 1, except for the scope of the database being searched. In short, for customer searches that originate through the business's place of business (webpage, physical location), the business can eliminate all other businesses from the trusted referral results. For customer searches that originate through a search engine (FIG. 1), all trusted referral results from all businesses could be shown. The actual location of the database may be relevant in such an instance.

The past customer has made a transaction with the business (210) and may have been given a copy of the business's privacy policy. (220) The business then creates a database of past customers and their products. (230) The business records the past customer's transaction in their database. (240) When a new customer is searching (250) for the same product on the business's app, website, or physical location, the new customer sees the FtF icon to begin their search for a trusted referral. The business could offer a kiosk in the business's physical location to allow new customers to search the business's database for past customers that they know. The in-store kiosk could have separate rules than online web-based searches. In-store search might contact past customers via text messages to get a more immediate response since the new customer could be waiting to make the purchase immediately. Web-based searches might be limited to only 1-2 inquiries to prevent fishing software from trying to reconstruct databases. Because this database does not contain other businesses' transactional data, new customer searches desirably cannot discover transactions from other competing products or businesses. The new customer allows the FtF software to assess their social network sites like Facebook or their contact list. (260) The FtF software cross-references the business's database with the new customer's social network to find some trusted referrals for that particular product. (270) The FtF software then notifies the new customer of the number of trusted referrals found (280) and asks for permission to release their name. (290) If permission is granted (300), then the trusted referral is contacted (330). If the trusted referral gives their permission to release their name (340), then the two customers talk and discuss the product. (370) The new customer can purchase the product (390). The past customer can send additional information like other products that they bought at the same time. (380) The new customers social network could be saved (401) or erased (402).

FIG. 3 depicts a flow diagram of another embodiment of a FtF software system where a new customer has created their FtF social network prior to their product search that allows enhanced search options. The new customer has created the FtF social network prior to searching for a product, so the matches between past customers and the new customer's social network can be determined as the web page is loading and the number of trusted referrals can be displayed on the webpage right next to the product in question. (FIG. 16)

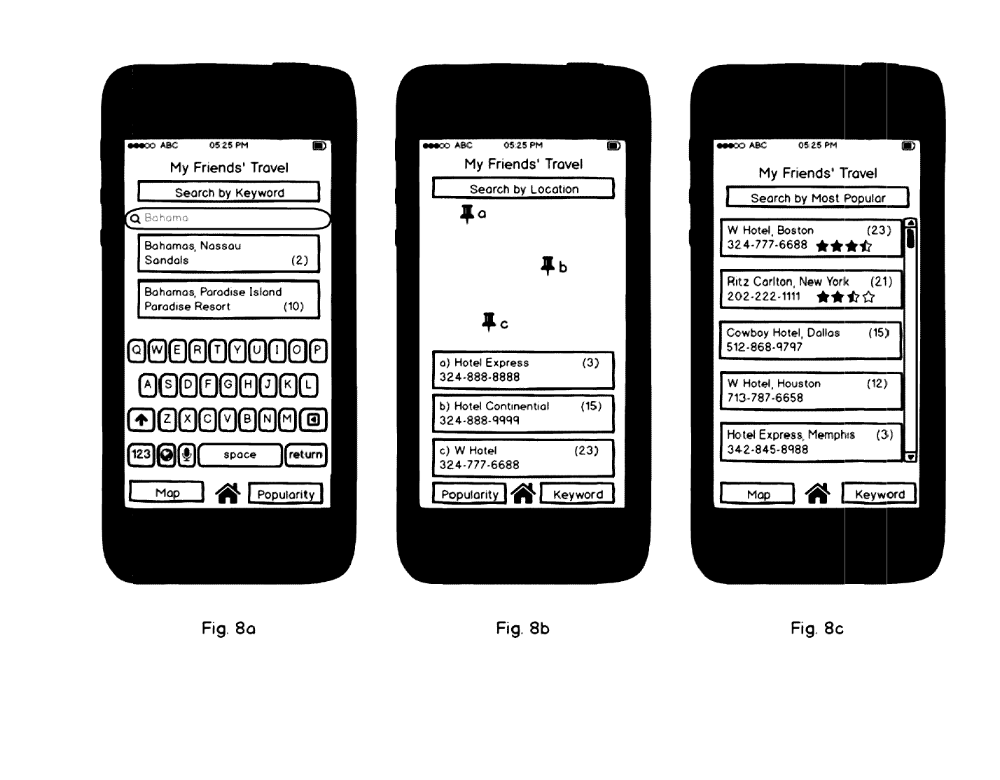

In FIG. 3, a database has been created and/or accessed similar to FIGS. 1&2. (610). The new customer has previously consented to allowing the FtF software to create a FtF network from their other social networks (same as FIGS. 1&2). (640) This consent could be continual and timeless or could be for a limited time like just the searches that are performed for one hour or a day on the web browser currently being used. The new customer might be searching for a product on a FtF website, a FtF app (FIG. 8) or another search engine website like Amazon (FIG. 16), Google, Bing, or Yahoo. (650) As the page is loading with the product information, the FtF software could cross reference the new customer's FtF social network with the past customers for the products being searched and other related products. (670) The trusted referrals can be identified and the number of referrals can be displayed along with the FtF icon right beside the product in question. (690 & FIG. 16). The rest of the flow diagram could be similar to those of FIG. 1&2, if desired.

The new customer could search for products based on their number of trusted referrals for that product and compare the most popular products to least popular products with their peer group. (665) For instance, a teenager could walk into a clothing store and search for a shirt that was most commonly bought by people on their Facebook friends list (or not bought by people on their friends list, to desirably avoid duplication of outfits at a special event, for example). If a parent wanted to buy their child the “coolest” new shirt, they could enter their child's Facebook account information into the FtF software. The child may or may not have to allow the use of their Facebook account. A notice could be sent real time to the Facebook user/child to authorize the use of their friends list. When permission was granted by the user/child, the parent could then see which shirts were popular with their child's friends. The parents may not be allowed to contact the past customers (their child's friends) that had previously bought the shirt. A search engine like Google might use the number of trusted referrals in the organic ranking of websites, search results, or products.

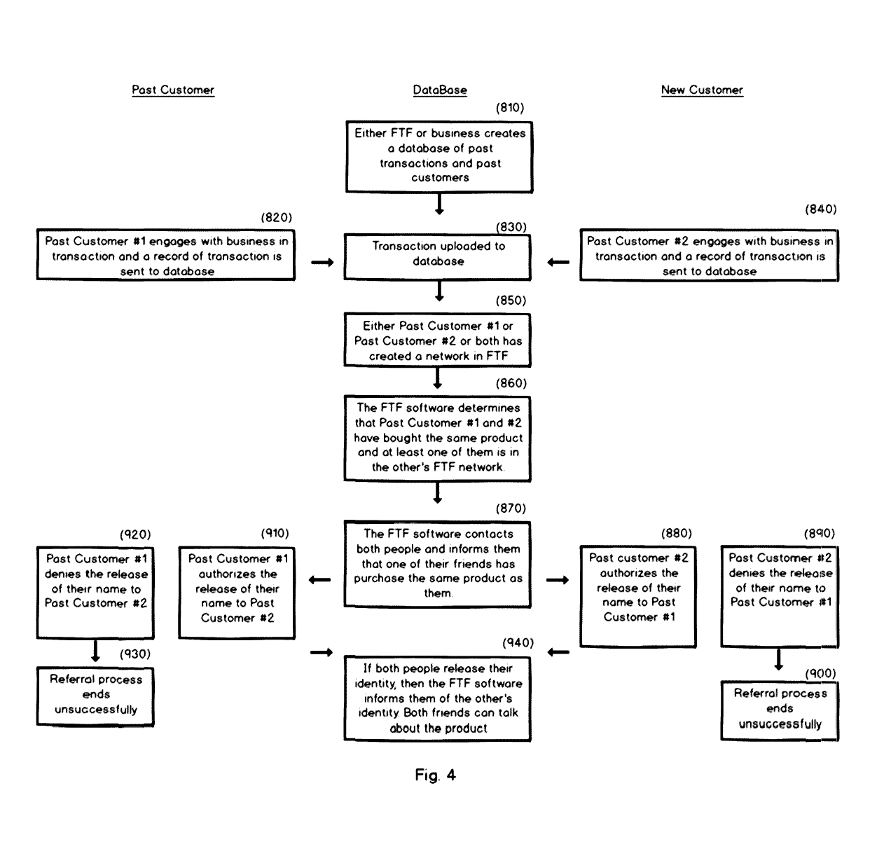

FIG. 4 depicts a flow diagram of another exemplary embodiment of a FtF software linking two past customers after they have purchased the same product or service. Either a centralized FtF database (FIG. 1) or a private business database (FIG. 2) could store the transactional data being searched.

Both past customer #1 (820) and past customer #2 (840) have purchased the same product and uploaded the transactional data to a database (830). At least one or both of the past customers has set up a FtF network. (850) The FtF software then identifies the two past customers as having purchased the same product and one of them being in the other's social network. (860) The FtF software then contacts both of them to ask permission to release their identity to each other. (870) The two people could release their identity without restrictions or release their identity only if the other party also releases their identity. (880 & 910) If both parties release their identity, then the FtF software can connect the two friends so they can discuss the product or business, as well as compare other product and/or services purchased by either party (which might include providing recommendations of potential past purchases made by one party to the other party—possibly impelling additional purchases by the other party).

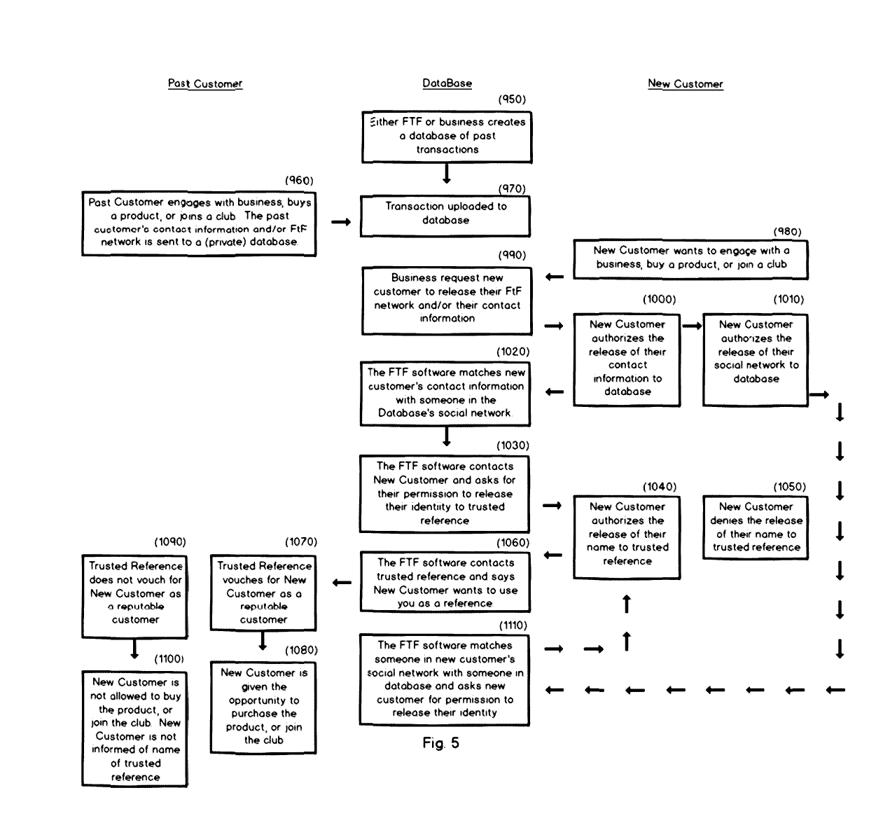

FIG. 5 depicts a flow diagram of a past customer vouching for a new customer. Certain businesses may not want to extend their services to all customers and may want to check references before they take on a new customer. Certain social clubs or popular nighttime clubs build a reputation as being exclusive where you may have to know someone to gain entrance or be allowed to participate in the activity. Therefore, certain clubs may require new customers to have a past customer to vouch for them as a reputable customer.

The business could be running a private database of their past customers. (950) A past customer may release their name, cell phone number, or email address to the business upon receiving services from the business. (960) The past customer information is stored in a database that could be private. (970) The database could have contact information from other trusted parties that were not past customers like friends and family of the business. A new customer may want to engage the business in a transaction but the business wants to check the new customer's references prior to offering them any services. (980) The business may require the new customer to submit their contact information and/or the social network. (990) The new customer could authorize the release of their contact information (1000) and/or the release of their social network (1010). If the new customer refuses both of these options, then the business might refuse services. The business may not even ask the new customer for permission to utilize the FtF network to check their contact information in their database. If the FtF software matched the new customer's information with the information in a social network in the database, then the FtF software could inform the new customer and/or the business of the match and ask the new customer for permission to contact this “trusted reference.” The new customer may or may not be informed of the name of the trusted reference. The FtF software could contact the trusted reference with the name of the new customer and the purpose of the request for a reference. (1060) The trusted reference could either vouch for the new customer (1070) thereby allowing the new customer to engage with the business (1080) or not (1090) thereby preventing the new customer from engaging with the business. (1100).

If the new customer also allowed the business to have access to their social network (1010), then the FtF software could cross reference the new customer's social network with the list of people in the database. If a trusted reference was found, then the FtF software could ask the new customer for permission to release their identity to the trusted reference. (1110) The new customer could authorize the release of their information to the trusted reference (1040) and the trusted reference could be contacted. (1060-1100) The FtF software could also ask the new customer for permission to release their information to any trusted reference (1040) when the business asks the new customer for their contact information and social network (990) and before the search for a trusted reference was performed.

For example, the new customer might want to remodel their house and is talking to a general contractor. The general contractor may want to know that this new customer is not likely to refuse to pay for the services after they are complete. The business may want to check out the new customer's references just as the new customer may want to check out the business's references.

The various software systems and business methods described herein can serve a multiplicity of purposes. First, when asking a new customer to identify a past customer to vouch for them, the business may not wish to just “hand over” a past customer list to the new customer and allow the new customer to just scroll through the list and pick someone. This flow diagram allows the “past customer list” to stay secret from the new customer. Second, this flow diagram allows the business to search all of the possible past customers that know the new customer to make sure that none of them object to the new customer joining the business or club. This greatly broadens the background check by immediately identifying all past customers that know the new customer and not just the past customers that the new customer feels will offer a kind referral. Third, the past customers that know the new customer can immediately respond to the request to vouch for the new customer. The business or club does not have to wait an extended length of time waiting for their past customers to get back to them to decide if they want to offer the new customer a position in their business. The past customers can immediate receive and reply to the electronic communication (text, email, etc.).

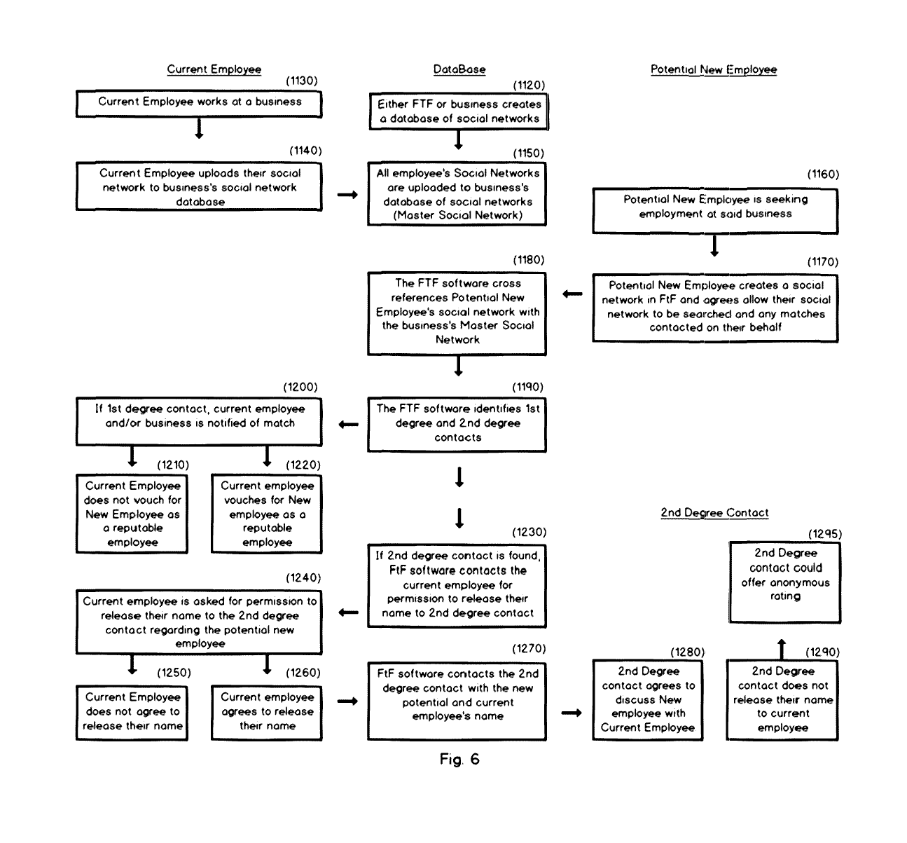

FIG. 6 depicts a flow diagram of another embodiment of a FtF software systems, which allows a current employee or business to check the references of a potential new employee through matching their social networks. Because it is so important to hire and train the right personnel, companies go to great lengths to do background checks and ask for references. The most important references are from people who the employer may already know (i.e. a trusted reference). Sometimes the employer may know someone who also knows the new potential employee. Typically, this process is called “playing the name game” to see whom the two parties might each know. This “name game” is usually helpful in generating positive referrals, but negative referrals may get missed, as one party may not offer up a name of someone who is likely to give a negative referral.

The business may create a network of all the current employee's social networks and use this master social network to screen new potential employees. (1150) The new potential employee could release their social network to the business. (1170) The FtF could identify first degree contacts (either the new potential hire was in an existing employee's network or an existing employee was in the new hire's network) or second degree contacts (an outside person was in both the new hire's network and an existing employee's network). (1190) First degree contacts could be handled in a manner similar to that disclosed in connection with FIG. 5. The first degree contact could be contacted for a referral. (1200) When a second degree contacts is found (1230), the FtF software could contact the current employee that knows the second degree contact to ask for permission to release their identity to the second degree contact. (1240) If the current employee allows their name to be released (1260), then the FtF software could communicate with the second-degree contact regarding the new potential employee and the current employee. (1270) The second degree contact could release their name to the current employee or business (1280), remain anonymous and not send a rating (1290), or remain anonymous and send an anonymous rating. (1295)

Although the example above is a new employee wanting to join a business, this flow chart could represent any two parties that mean to enter into any arrangement for any business purpose. For example, a venture capital fund might want to check out the references of a company's management team. A bail bondsman might want to check out the references of a client who they are about to lend money to make a bail payment.

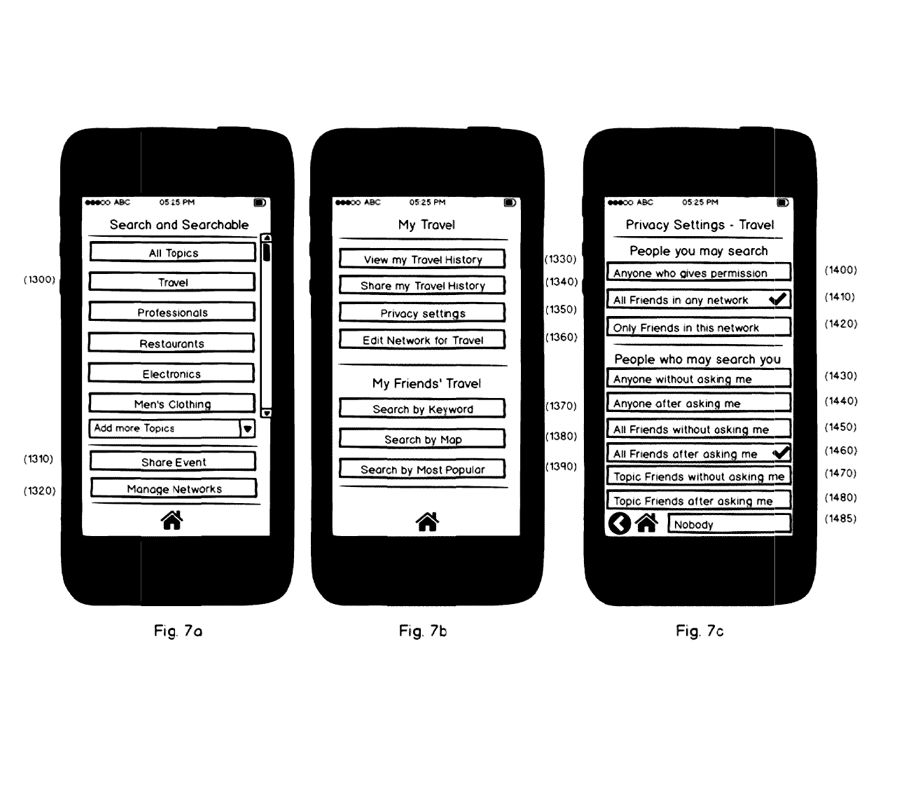

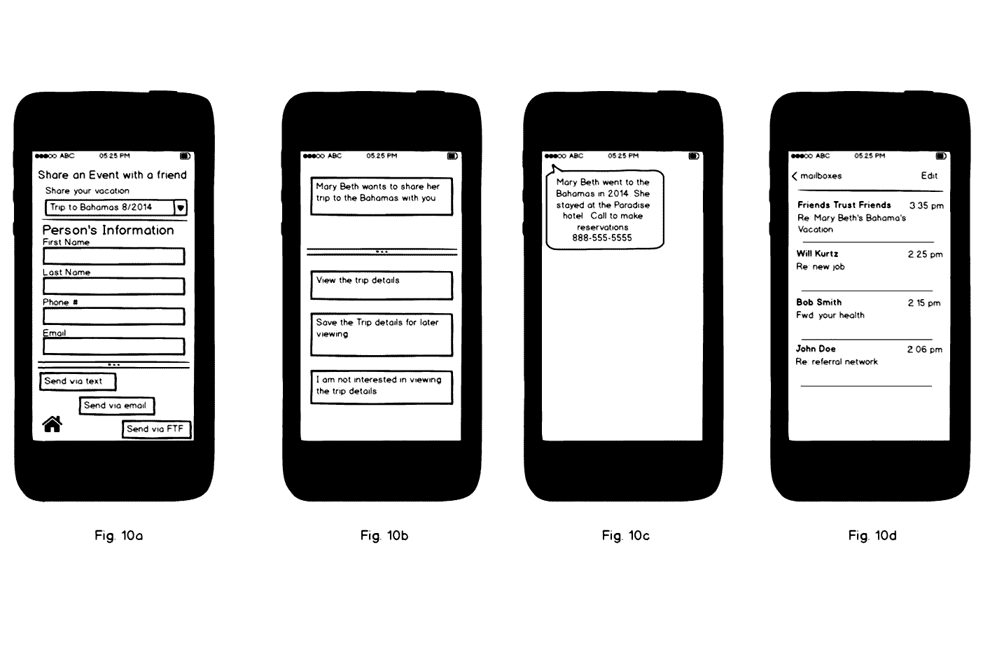

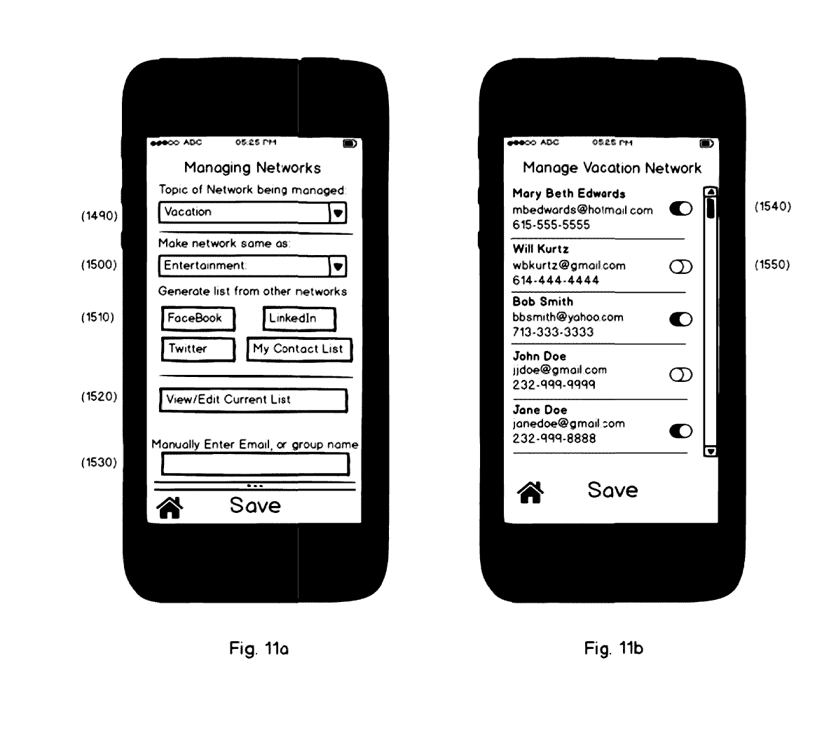

FIGS. 7a, 7b, and 7c depicts a potential home screen shot of the application with different searchable topics. In FIG. 7a, the user can select which topic they are interested in searching. (1300) At the bottom of FIG. 7a, the user can select the “share event” icon (1310&1340) which would take the user to FIG. 10a, where they can select the event they want to share and which friend they would like to share the event with. At the bottom of FIG. 7a, the user can actively manage their networks (1320) by selecting the “manage networks” icon, which takes the user to FIG. 11.

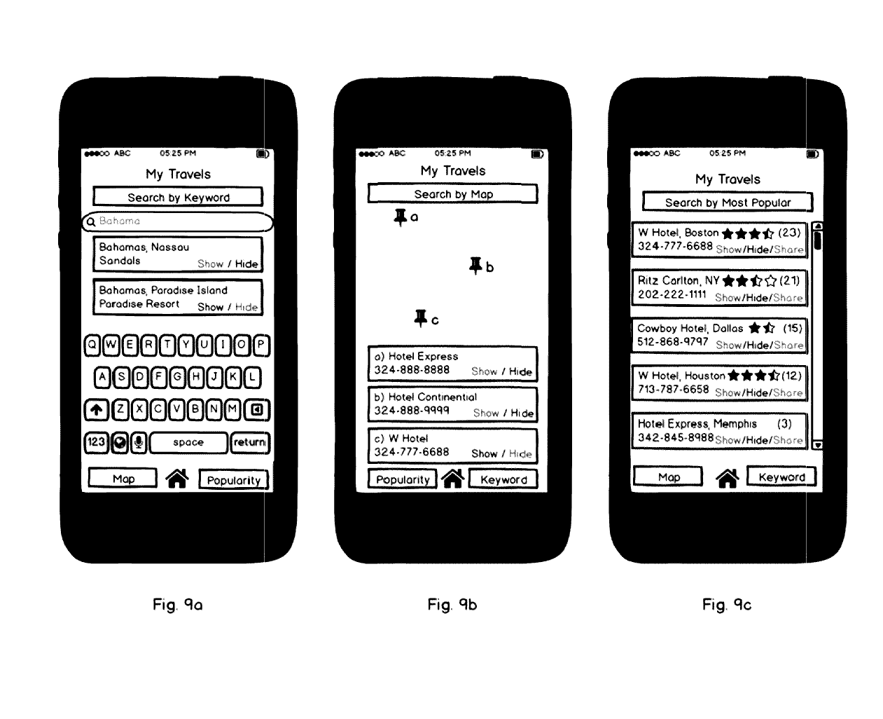

In FIG. 7b, the user has selected the Travel icon from FIG. 7a. The user can select the “view my travel history” icon (1330), which allows them to view and edit their previous events as seen in FIG. 9. The user can select the “Share my travel history” icon (1340), which allows the user to select an event (FIG. 9c) in their database and send it to a friend as seen in FIG. 10. The user can select the “Privacy Setting” icon (1350), which allows the user to determine who they search and who searches them as seen in FIG. 7c. The user can select the “Edit network for travel” icon (1360), which allows the user to edit which other users are included in their network for that specific topic as seen in FIG. 11. At the bottom of FIG. 7b, the user can select the “Search by Keyword” (1370), which takes the user to FIG. 8a. The user can select the “Search by Map” icon (1380), which takes the user to FIG. 8b. The search by map function could be helpful for vacation packages or travel sites. The user can select the “Search by Most Popular” icon (1390), which takes the user to FIG. 8c.

In FIG. 7c, the user can select different levels of privacy for both searching friends (1400, 1410, 1420) and being searched by friends (1430-1480). The top three icons, “Anyone who gives permission” (1400), “All friends in any network” (1410), and “only friends in this network” (1420) can be used to determine the people that this user wants to search in this given topic. The “anyone who gives permission” icon (1400) allows the user to search for anyone who gives their permission to be searched. The user may not know the person that is being searched, so the referral might be felt to be untrustworthy. Since users can create different networks for different topics (FIGS. 11a & 11b), some topics (travel, hotels, restaurants, automobiles) that are rare or public may be better served with larger networks of friends and other topics (health, finances, etc.) that are private or common may be better server with smaller and closer networks of friends. The “all friends in any network” icon (1410) allows the user to search for anyone in any of the user's networks for any topic. This option would be a much broader group of friends to search and could be used to search for activities that were relatively rare (rental house in Bora Bora) or activities that were relatively public (restaurants). The user would still likely know the friends that were being searched, but the user might be willing to ask a larger network of acquaintance about the activity in hopes that there would be more connections. The “only friends in this network” icon (1420) allows the user to search for anyone that was just in the network for this one topic as determined in FIG. 11b. Since both parties are going to have to be comfortable discussing the reasons for the activities, a more private network makes sense for certain topics.

At the bottom of FIG. 7c, the user can select different levels of privacy for being searched by friends (1430-1480). The “anyone without asking me” icon (1430) would allow everyone and anyone to see the activity in this topic without the user controlling the release of information. The user might be able to see the release of the information after it was released if they wanted to see who was searching their activities (not shown). This option would be comparable to the FourSquare app of posting that you ate at a particular restaurant for all interested people to see. The “anyone after asking me” icon (1440) would allow the FtF software to contact the user when another user wanted some information about a particular activity. The user could be given some information about who was requesting the information and then the user could decide on a case-by-case basis if they wanted to release their information to that person requesting the information. This might be helpful for people with a rare medical disease who would not mind sharing their experience with someone else who also had the disease. The “all friends without asking me” icon (1450) would allow any friend in the user's networks or a friend who had the user in their network to see the user's activity in this topic without the user controlling the release of information. The user could see who was searching this activity after the information was released either through an “after the fact” push notification to the user or as an icon in the app that the user could look to see who was searching the user's activities. This option could be comparable to a posting on FaceBook. The “all friends after asking me” icon (1460) could allow the FtF software to contact the user when the user's friend(s) wanted some information about a particular activity or product. The “all friends” could be anyone who was in the user's networks or anyone who had the user in their network and not specifically blocked by the user. The user could be given some information about who was requesting the information and then the user could decide on a case-by-case basis if they wanted to release their information to their friend requesting the information. The “topic friends without asking me” icon (1470) could allow any friend in the user's specific network for that specific topic to see the user's activity in this topic without the user controlling the release of information. The user could see who was searching this activity after the information was released either through an “after the fact” push notification to the user or as an icon in the app that the user could look to see who was searching the user's activities. The “topic friends after asking me” icon (1480) could allow the FtF software to contact the user when the user's friend who was in the topic specific network wanted some information about a particular activity. The user could be given some information about who was requesting the information and then the user could decide on a case-by-case basis if they wanted to release their information to their friend requesting the information. This option could allow for the most privacy and security. The user could also be given the option to not share any information with anyone (1485).

FIGS. 8a, 8b and 8c depict one embodiment of a new customer searching through the FtF database for events that one of their anonymous friends has experienced. The new customer can search through a topic by key word (FIG. 8a), by location (FIG. 8b), by popularity (FIG. 8c), or by ratings. As the user types in their keywords, the closest related topics in the FtF database show up below the listings. In this example, the user types in Bahamas, and the related topics of Sandals Resort in Nassau and Paradise Resort in Paradise Island show up. The app tells the user how many of their friends have experienced these topics; 2 for Sandals and 10 for Paradise resort. The new customer could select the business's icon and immediate purchase an event (not shown) or call to make a reservation. The business could be charged on a per click or subscription basis.

In FIG. 8b, the new customer can search from a map to see what activities their friends have done around a given geographic area. The events shown are the names of three hotels that their friends have stayed in. Displayed are the numbers of friends that stayed in each hotel. The new customer could select the hotel icon and immediate make a reservation.

In FIG. 8c, the new customer can search from a list of the most popular events or activities with their friends in a given topic. The events shown are hotels that friends have stayed in. Other topics that new customers might want to search by most popular could be restaurants, clothes, vacations, wines, etc. The user could also search by the events with the highest ratings from their friends.

FIGS. 9a, 9b, and 9c depict a screen shots of the user viewing and editing their own events in a topic. The user could scroll through all of their events and decide which events to show or hide from other people's searches and which events to share. The events could be shown in chronological order, most frequently appearing, or alphabetical order. Events that are hidden might not be searchable by the user's friends or people in their network. Events that are shown could be searchable using whatever search criteria the user selected in FIG. 7c. The user could also select an event to share with a friend, which could take the user to FIG. 10. The user could also view and edit their previous ratings for a particular event.

FIGS. 10a, 10b, 10c, and 10d depict a screen shot of the application where one friend can share details about an event or experience with another friend. There is often a need for friends to be able to recall details about past events and purchases and then to be able to share those events with friends. A user could get to this screen shot by selecting the share an event icon in FIG. 7a or 7b and then picking the event in FIG. 10a. A user could also get to this screen shot by selecting an event and then opting to share that event in FIG. 9c. For instance, one person may have traveled to the Bahamas 2 years ago. A friend who is planning a trip to the Bahamas might contact them through the FtF app or normal social channels (dinner party, etc.). The person who traveled to the Bahamas may not remember the name of their hotel, the phone number of the hotel, where they ate that great dinner on the beach, etc. The person could look up their trip details with the FtF app (FIG. 7b), which recorded the details of the trip during their vacation. With the push of a button, the person could share all of the details with their friend (FIG. 10a) through the FtF app (FIG. 10b), a text message (FIG. 10c) or an email (FIG. 10d).

Another example could be restaurant reviews. One person may have eaten at a new restaurant. They may have used a reservation app like Open Table to schedule the dinner reservation. The person's electronic record of that dinner could be sent over from Open Table to the person's FtF app on their smart phone. The person's smart phone's GPS or beacon may have recorded their location at the restaurant (FIG. 13) and sent that information to the FtF app. The person may have manually entered their experience in the FtF app. (FIG. 12) The FtF app could scan the person's credit card purchases with their permission and determine that the person had eaten at that restaurant. This person may want to refer a friend to their favor restaurant. They could first search the restaurant topics in FIG. 7a, then select the restaurant that they wanted to share in FIG. 9c, and then enter some of their friend's information in FIG. 10a, and finally send that referral through the FtF app (FIG. 10b), text messaging (FIG. 10c), or email (FIG. 10d).

FIGS. 11a and 11b depicts a screen shot of the application where the user can manage and edit the network on an individual topic level. There may be a need for the user to select different groups of friends for different topics. For instance, a user maybe comfortable discussing restaurants with people at work, but they might be unwilling to discuss health issues with those same people. Therefore, the user might want to have a large network of friends to discuss the best restaurants in town and a small network of only close friends to discuss their health issues. Some topics of obscure nature might require a large network of friends to increase the chance that searches in that topic might reveal a friend that has some experience in that topic. For instance, someone might have a large travel network because they want to find the best rental house in the Bahamas, so they would be willing to create large networks of friends to improve the chance that they might find someone who could help them.

In FIG. 11a, the user could edit and manage their network for a particular topic. The user could first select the topic they want to manage. ((1490) The user could decide to link the network for this topic to one or more of the other topic specific networks. (1500) The user could generate a network from external networks like Facebook, Linkedin, Snapchat, Google +, Twitter, contact list on their mobile device and other social networks. (1510) The user could view or edit the current list of friends in the topic specific network, which would take the user to FIG. 11b. (1520) The user could manually enter an email or cell phone number to add an individual to the network. The user could manually enter a group name to add a list of people to their network. A third party could manage the names on the group list. If a user shared an event with a person, the software could prompt the user to add the person to their network.

In FIG. 11b, the user could scroll through a list of potential people to include in the topic specific network. The user could toggle on and off to include the person in the network (1540) or not. (1550) The user could block a user from being searched or searching them.

FIG. 12 depicts a screen shot of the application with a manual entry of an event, activity, or purchase into a database. The application could allow the customer to enter their purchases and events manually. The FtF software could prompt the user for specific events at random times to include in the database. For instance, the FtF software might expand their searchable activities to include general contractors and send out a notice to all FtF users asking if they have remodeled their house in the past 10 years and can recommend a good general contractor to their friends. The user could then enter their general contractor's name, information, and rating so that the user's friends might be able to benefit from the user's experiences. The user could be more inclined to enter the information because they know they are helping their friends and that they could learn who wanted to see their information before the information is released. The general contractor could then benefit and market the positive reviews from past customers.

FIG. 13 depicts a screen shot of the application making an educated guess about the user's activity and requesting that the user include that activity in their FtF database. That application could use the location services (GPS, Wifi, beacon technology) on the customer's electronic device (smart phone, tablet computer, laptop) to discern the customer's location. The application could then make a reasonable assumption about the customer's behavior and then prompt the customer to confirm that they were indeed engaged in that behavior. The application could also prompt the customer to include that activity in their FtF database. The FtF software could use past searches to predict future activity and ask the user to include that activity in their database.

Examples of this functionality could include determining that a customer is on vacation by noticing through the customer's smart phone GPS that they are in a resort city for multiple days. The FtF app could query the customer about the resort that the customer is staying in. Another example could be where the smart phone GPS notices that the customer spent 2 hours around dinnertime in a restaurant and determine that the customer probably ate dinner there. The app could ask them to rate their experience at that restaurant.

FIGS. 14a and 14b depicts a screen shot of the application where a business might manually invite certain customers to upload their experience and/or transactions into the FtF customer database. This customer invitation to enter data into the FtF network could easily be automated as well and not require a manual process. Some businesses may not submit customer encounters into a database because of privacy concerns or a lack of information about the customer (i.e. customer rating). For instance, the business may not collect email addresses from customers, but could place a kiosk in the lobby where a customer could manually enter this data into the database. The business could handle sensitive information like healthcare where the customer needs to actively acknowledge that their information is being stored in the database and give consent as shown in FIG. 14b. In FIG. 14a, the business user could enter certain customer data into the invitation like the customer's name (1560), the transactional data (1570), and some customer's contact information. (1580) The business user could then send the invitation to the customer (FIG. 14b) through the FtF app.

In FIG. 14b, the customer could be asked (1590) to share their information in the FtF database with everyone (1600), with only their friends (1610), or with no one. (1620) The customer could also be prompted to rate the business (1 to 5 stars) or not and that rating could be automatically shared with everyone, shared only with his or her friends, shared anonymously, or shared with their name attached to the rating. (1630) The customer could refuse to rate the business. Businesses could edit their past customer list based on the customer's ratings.

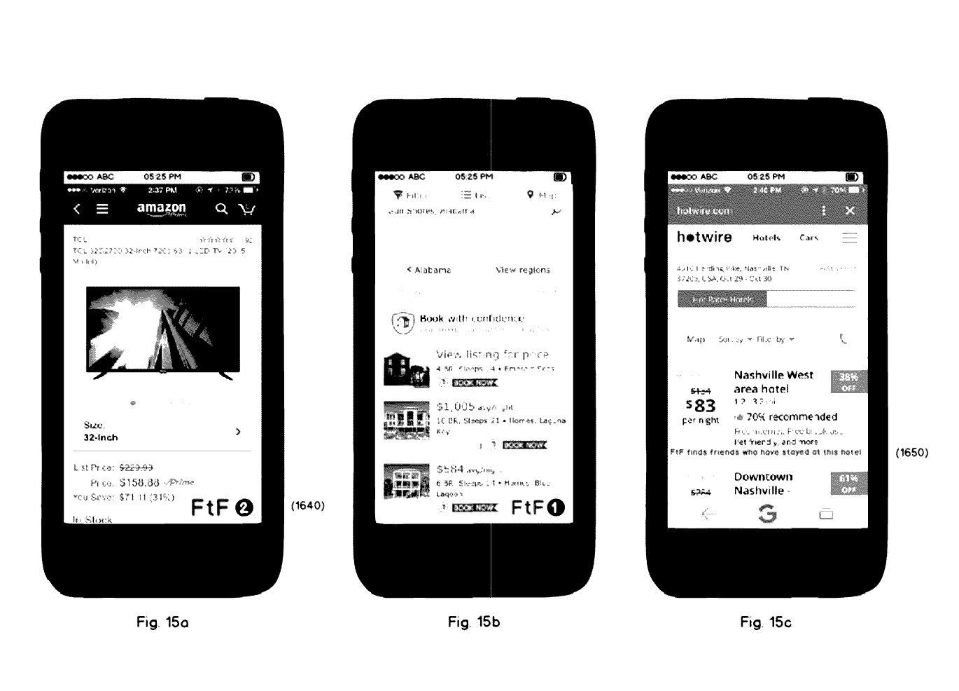

FIGS. 15a, 15b and 15c depict a third party mobile application running the FtF software inside their app. In FIG. 15a, the FtF icon with a white number is seen at the bottom right corner for an ad for a new TV where the user has created a FtF network prior to their search. (1640) The white number indicates the number of trusted referrals for this particular product on this search engine. In FIG. 15c, the sentence with red words can inform a user that does not have a social network stored in the FtF database that the user can possibly find a friend that has stayed at this hotel and ask them about their stay. (1650)

FIGS. 16a and 16b depict a webpage running the FtF software inside their page where the user has already set up their FtF social network prior to product search. In FIG. 16a, a list of multiple books is shown in an Amazon webpage with the FtF icons shown right below the book title. The FtF icon shows the number of trusted referrals that exist for this user's social network and this book title. In order for the number of trusted referrals to be shown below the book title though, the user could have created a social network in the FtF software previously and allowed the FtF software to access their web book search through a cookie in their browser.

In FIG. 16b, the user has scrolled over or clicked on the FtF icon and a pop up window appears over the book title with instructions. The user is asked if they want to text or email the trusted referrals and give permission for their name and product to be released to the trusted referrals. The text message could show the number of trusted referrals for the product and/or business.

FIGS. 17a, 17b, 17c, 17d and 17e depict a webpage running the FtF application where the user has not set up their FtF social network prior to product search. In FIG. 17a, the user is searching for a book and below the book title is a sentence explaining that the FtF software can find a trusted referral if the user so chooses. In FIG. 17b, the user could select which social networking site they would like to use to create their FtF social network. In FIG. 17c, the user has to sign into the social networking site to allow FtF to access their “friends” list from that social site. In FIG. 17d, the user is informed of the number of trusted referrals for that product and/or business and given an opportunity to contact them via text, email, or other mode of communication. In FIG. 17e, the user is asked to save their FtF social network in the FtF software indefinitely, for a limited time, or delete it. The user may want to search for other book titles at the same or later time and may prefer to see the FtF trusted referrals for all products without having to create the FtF social network for each product each time. If the user selected the indefinite FtF social network, then the user's additional searches could be displayed in a manner similar to that of FIG. 16a. If the user selected the limited time FtF social network, then the user's additional searches could be displayed like FIG. 16a for that amount of time. After the specified amount of time, the user might have to recreate their FtF social network again. (FIG. 17a) If the user selected the delete the FtF social network, then the user's additional searches could be displayed like FIG. 17a and the user could recreate their FtF social network again for each product.

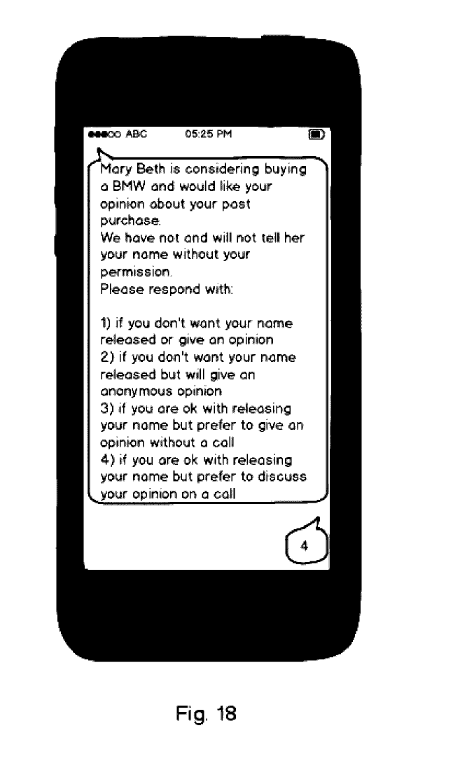

FIG. 18 depicts a text message being sent to a past customer from the FtF software asking for a referral on a product on behalf of a friend. The past customer is informed of the friend making the request and the product in question. The past customer can refuse to release both their name and a rating, refuse to release their name but will send an anonymous rating, release their name and give a simple rating, or release their name and ask the friend to call them to discuss their opinion. The past customer could respond by typing in the appropriate numbered respond. This message could also be sent via an email or other form of communication.

There are forms of media that can be directed to a known user. For instance, Pandora requires a user to log on to their website with a log in ID which is your email address and a password. Pandora can then send you advertisements based off information from your email. The FtF software could ask the user for permission to improve their Pandora experience. When an advertisement played from a business that contributed data to a FtF database, then the Pandora streaming music could include an audio message stating that the user has 2 trusted referrals from this product. The user could then access those trusted referrals through the Pandora website. In addition, many cable carriers and new TVs link an email address with a home's cable boxes. The advertisements that come across that cable TV could also display the number of FtF trusted referrals for displayed products based off the email listed to that home's cable box.

Because an advertisement that also carried a high number of trusted referrals could be more relevant to the viewer, listener or possible customer, the businesses that try to direct advertisements to the best possible customers could potential charge more for advertisements that were sent to customers that had a high number of trusted referrals. Businesses that sell products could want to show their products to potential customers whose friends have recently purchased their products. This selected advertising could have a higher conversion rate and is therefore more valuable. Advertising agencies could also preferentially target advertisements to potential customers who had a higher number of trusted referrals and charge more for that advertisement. In a similar manner, “suggested gift” items for an acquaintance or a member of one's trusted network could be provided to a user based on analysis of the acquaintance's past similar purchases (i.e., replacement ink cartridges for a printer recently purchased by the acquaintance), as described herein.

The FtF software could attempt to detect and thwart a user's malicious attempt to pry into someone else's transactional data. For instance, if a user made multiple changes to their social network in a short period of time to try to isolate one individual that the user wanted to gain information on, then the FtF software could refuse to shown any trusted referrals, show an incorrect number of trusted referrals, or inform the user that their behavior appeared suspicious. If the user's social network was not diverse enough or had only one or two outliers, then the FtF software could thwart the user's malicious behavior. The FtF software could only allow a small number of changes to a social network in a given time to prevent the user from stacking their social network to obtain data on one person. The FtF software could have a minimum number of people in their social network to consider the network valid and searchable.

The FtF software could also try to determine how close a trusted referral is to the new customer by analyzing the communications (emails, text messages, phone calls, etc.) between the new customer and the trusted referral. A trusted referral could be considered closer if the user was also in the trusted referral's social network as well. The FtF software could contact trusted referrals that “seemed” closer to the new customer first, and leave more distant trusted referrals for later contact, if desired. This preferential contact to closer contacts could help connect the user with closer friends first and then let the user expand their search if they did not get their questions answered. This feature could help limit the fatigue of asking multiple people for referrals.

The system and methods described herein, and associated software applications, desirably connect a new potential customer with a past customer that is known to the new customer through a private single business database or a shared multiple business database. Past customer identity protection can be paramount, if desired, and their identity is released to a new customer only after the past customer grants permission. Past customers can have an opportunity to edit their information in the database as well as who has access to their information. The number of connections or trusted referrals may convey how popular a certain product is with a customer's peer group and therefore how relevant the product is to the customer. The number of trusted referrals for a certain product could be used for directing search engine results, targeting advertisements to appropriate customers, and defining the cost of advertisement.

One significant difference between the disclosed inventions and other transactional database software is that the current inventions can include records of point of sale transactions and ask the customer for permission to release this data when the information is requested by a friend which gives the past customer control of their data at the time of information release. This is a significant improvement over other databases which may try to ask a past customer for permission to release data when the data is collected and/or where the customer does not ability to review the information request and approve or deny the release of data on a case by case basis.

### INCORPORATION BY REFERENCE

The entire disclosure of each of the publications, patent documents, and other references referred to herein is incorporated herein by reference in its entirety for all purposes to the same extent as if each individual source were individually denoted as being incorporated by reference.

### Equivalents

The invention may be embodied in other specific forms without departing from the spirit or essential characteristics thereof. The foregoing embodiments are therefore to be considered in all respects illustrative rather than limiting on the invention described herein. Scope of the invention is thus intended to include all changes that come within the meaning and range of equivalency of the descriptions provided herein.

Many of the aspects and advantages of the present invention may be more clearly understood and appreciated by reference to the accompanying drawings. The accompanying drawings are incorporated herein and form a part of the specification, illustrating embodiments of the present invention and together with the description, disclose the principles of the invention.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the disclosure herein.

What is claimed is:

1. A method of coordinating the transfer of a past or future review of a product or service between a data server and one or more client devices over a data network, the method comprising;
receiving a plurality of information packets regarding a plurality of purchases of a product or service over said data network for storage in a past customer database on the data server, wherein each of said information packets contains information identifying an individual customer with or without a customer review of the product or service and at least one member of a review group consisting of an individual business, an individual product, and individual service provider and an individual service;
receiving an information request over said data network from a prospective customer using the one or more client devices, the information request identifying the prospective customer and at least one member of a proposed review group consisting of a prospective product, a prospective service, a prospective business and a prospective service provider;
utilizing said information request to access one or more third-party databases containing social networking relationship data relating to said prospective customer, and creating a social network map to identify at least one individual customer in said past customer database that is related on said social networking map to said prospective customer;
comparing the at least one member of the review group for the identified past customer to the at least one member of the proposed review group for the prospective customer to identify one or more matching review group members, and creating a matching review group member list;
delivering the matching review group member list to the one or more client devices for display to the past and/or prospective customer;
sharing any previously recorded customer reviews regarding the matching review group member list from the past customer with the prospective customer and/or obtaining a new customer review regarding the matching review group member list from the past customer and sharing the new review with the prospective customer.

2. The method of claim 1, further comprising the step of obtaining permission from the prospective customer to disclose the identity of the prospective customer and one or more matching review group members to the past customer.

3. The method of claim 1, further comprising the step of obtaining permission from the past customer to disclose the identity of the past customer and one or more matching review group members to the prospective customer.

4. The method of claim 1, wherein the prospective customer is an online customer.

5. The method of claim 1, wherein the prospective customer is a traveler.

6. The method of claim 1, wherein the prospective customer is a restaurant diner.

7. The method of claim 1, wherein the prospective customer is a user of a software program.

8. The method of claim 1, wherein the prospective service is an internet-based product.

9. The method of claim 1, wherein the prospective product is an internet-based service.

10. A method of coordinating the delivery of transferable product or service provider review information between a provider server and one or more client devices over a data network, the method comprising:
receiving product or service provider review information over said data network for storage in a database, wherein said product or service provider review information includes but is not limited to the information of an individual past customer, an individual product or service provider and/or a product or service;
receiving an information request over said data network from a prospective customer using the one or more client devices, the information request identifying the prospective customer and at least one of a prospective product or service providers and/or a prospective product or service;
utilizing said information request to access one or more third-party databases containing social networking relationship data relating to said prospective customer and/or the contact list of said prospective customer's electronic device, and mapping said social networking relationship data to identify one or more of said individual past customers having a matching relationship to the prospective customer;
utilizing said information request and said identified matching relationship to generate a list of relevant product or service provider review information; and
delivering the list of relevant product or service provider review information to the one or more client devices for display to the prospective customer.

11. The method of claim 10, further comprising a step of requesting and receiving disclosure authorization from the individual customer before the step of delivering the list of relevant product or service provider review information to the one or more client devices for display to the prospective customer.

12. A system for improving the reliability of customer review information, comprising:
a review database module comprising a plurality of past customer purchases or interactions with a business, each of the plurality of customer purchases linked to an individual customer identifier;
a prospective customer request module, which receives an information request from a prospective customer, the information request containing a prospective customer identifier and at least one of a prospective product or service and/or a prospective business identifier;
a relationship identification module, which accesses one or more third-party social networking website databases and/or the contact list of a smart phone device and utilizes the prospective customer identifier and the plurality of past customer identifiers possibly linked to the plurality of customer reviews to identify one or more pre-existing matching relationships between the prospective customer identifier and the plurality of past customer patient identifiers; and
an optional review delivery module that generates a matching review list of the available customer reviews corresponding to the matching relationships, obtains new customer reviews corresponding to the matching relationships and adds them to the matching review list, and delivers the matching review list to the prospective customer for review; and
a customer communication module that obtains permission from both the prospective and past customer to release their information to the other party and facilitate communication between the two parties through a phone call, text message, email or other digital communication.

13. The method of claim 12, wherein the prospective customer is a medical patient.

14. The method of claim 12, wherein the prospective customer is a traveler.

15. The method of claim 12, wherein the prospective customer is a restaurant diner.

16. The method of claim 12, wherein the prospective customer is a user of a software program.

17. The method of claim 12, wherein the prospective product or service is a surgical procedure.

18. The method of claim 12, wherein the prospective product or service is a medical product.

19. The method of claim 12, wherein the business is a hospital.

20. The method of claim 12, wherein the business is a physician.
